(19) United States
(12) Patent Application Publication
(10) Pub. No.: US 2008/0104081 A1
(43) Pub. Date: May 1, 2008

(54) Tiered storage system with single instance function

(76) Inventor: Yasuyuki Mimatsu, Cupertino, CA (US)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/589,227

(22) Filed: Oct. 30, 2006

(51) Int. Cl. G06F 17/30

(52) U.S. Cl. 707/10

(57) ABSTRACT

In a tiered storage system, unintended degradation of performance, reliability and security caused by applying a single instance function to the data in the storage system is avoided. When multiple identical files are stored in the storage system, the storage system determines whether the single instance function should be applied to the identical files or not, and a tier into which the actual instance of the data is stored, depending on the characteristics of the tiers. Thus, performance, reliability and security are maintained at the same level as when the single instance function is not applied. The invention may be implemented when the single instance function is applied to files in the same tier, or when the single instance is applied according to specified groups of logical volumes, so that the single instance function is applied to files in the same group even if the group encompasses multiple tiers.

### BACKGROUND OF THE INVENTION

1. Field of the Invention

The present invention relates generally to tiered storage systems.

2. Description of Related Art

Large storage systems in use today are able to contain various types of storage devices or media, such as FibreChannel (FC) hard disk drives (HDDs), Serial Advanced Technology Attachment (SATA) HDDs, and the like. Each kind of storage device has different characteristics and forms a separate ‘tier’ of storage. Higher tier devices, such as FC HDDs are more expensive and are appropriate for storing smaller amounts of data that require high performance and high reliability, such as faster and more accurate seek and read/write operations, and less chance of failure. Lower tier devices, on the other hand, such as SATA HDDs are less expensive and are appropriate for storing large amounts of data that do not require as high performance and reliability. In a situation where only expensive storage devices, that is, only a higher tier of storage devices are used to store all of the data, a storage system is able to provide high performance and high reliability for all the data, but the cost of the storage system is relatively quite high. Accordingly, by including storage devices of more than one tier in a storage system, and by appropriately assigning the storage devices to the storage of various types of data suited to their tier, the storage system is able to provide necessary performance and reliability at a reasonable cost. US Patent Application Publication No. 2001/0054133, entitled “Data Storage System and Method of Hierarchical Control Thereof”, to Murotani et al., filed Feb. 23, 2001, the disclosure of which is incorporated herein by reference, discloses a storage system that includes storage hierarchies.

Another technique for reducing the cost of storage systems is disclosed in U.S. Pat. No. 5,813,008 to Benson et al., the disclosure of which is incorporated herein by reference. Benson et al. provide a method to reduce consumption of storage capacity by using “single instance identifiers” that identify common portions of files and thereby avoid storing multiple versions of identical data. Under this method, when a number of files exist that contain portions in common, the unique portion of each file refers to only a single instance of the common portion stored in the storage system.

Both of the above techniques are effective for reducing costs in implementing storage systems. The use of the single instance function can be very effective in reducing consumption of storage capacity, and has been applied successfully in non-tiered storage systems. However, if the single instance function and tiered storage are used simultaneously, expected performance and reliability can fail to be provided. For example, when a file is stored in a lower tier and another file which has an identical content is written to a higher tier to obtain higher performance and reliability, the single instance function detects that these two files are identical and avoids storing the new file to the higher tier. This results in the new file being viewed by a host as if the file is stored in the higher tier of storage, but actually it is stored in a lower tier and expected characteristics (e.g., performance and reliability) are not obtained.

### BRIEF SUMMARY OF THE INVENTION

The invention includes a method and system in which a single instance function effectively reduces the consumption of storage capacity in a tiered storage system while not affecting expected characteristics of the stored data. When multiple identical files are stored in the storage system, the storage system determines whether or not the single instance function should be applied to the files, and also determines a tier of storage into which the actual data should be stored, depending on the characteristics of the tiers. Thus, the consumption of storage capacity is effectively reduced without affecting expected characteristics of the stored data. These and other features and advantages of the present invention will become apparent to those of ordinary skill in the art in view of the following detailed description of the preferred embodiments.

### BRIEF DESCRIPTION OF THE DRAWINGS

The accompanying drawings, in conjunction with the general description given above, and the detailed description of the preferred embodiments given below, serve to illustrate and explain the principles of the preferred embodiments of the best mode of the invention presently contemplated.

FIG. 1 illustrates an overview of an exemplary computer storage system in which the method and apparatus of the invention may be applied. FIG. 2 illustrates a logical volume table that contains external paths by which host computers identify logical volumes and tier of storage for each volume.

FIG. 3 illustrates an external path table that contains the external paths by which host computers identify files.

FIG. 4 illustrates an internal path table that contains instance ID and an internal path that used by the storage system to locate an instance of a file.

FIG. 5 illustrates the process flow of a storage system control program to process received commands from host computers.

FIG. 6 illustrates an exemplary process flow of a Write command.

FIG. 7 illustrates an exemplary process flow to correct location of an instance.

FIG. 8 illustrates an exemplary process flow of a Read command.

FIG. 9 illustrates an exemplary process flow of a Delete command.

FIG. 10 illustrates an exemplary process flow of a Move command.

FIG. 11 illustrates a grouping table that defines groups of logical volumes.

FIG. 12 illustrates an exemplary processing of a write command in embodiments using volume groups.

FIG. 13 illustrates an exemplary processing of a move command in embodiments using volume groups.

FIG. 14 illustrates an exemplary process to correct location of an instance in embodiments using volume groups.

### DETAILED DESCRIPTION OF THE INVENTION

In the following detailed description of the invention, reference is made to the accompanying drawings which form a part of the disclosure, and, in which are illustrated by way of example, and not of limitation, specific embodiments by which the invention may be practiced. In the drawings, like numerals describe substantially similar components throughout the several views. Further, the drawings, the foregoing discussion, and following description are exemplary and explanatory only, and are not intended to limit the scope of the invention or this application in any manner.

System Architecture

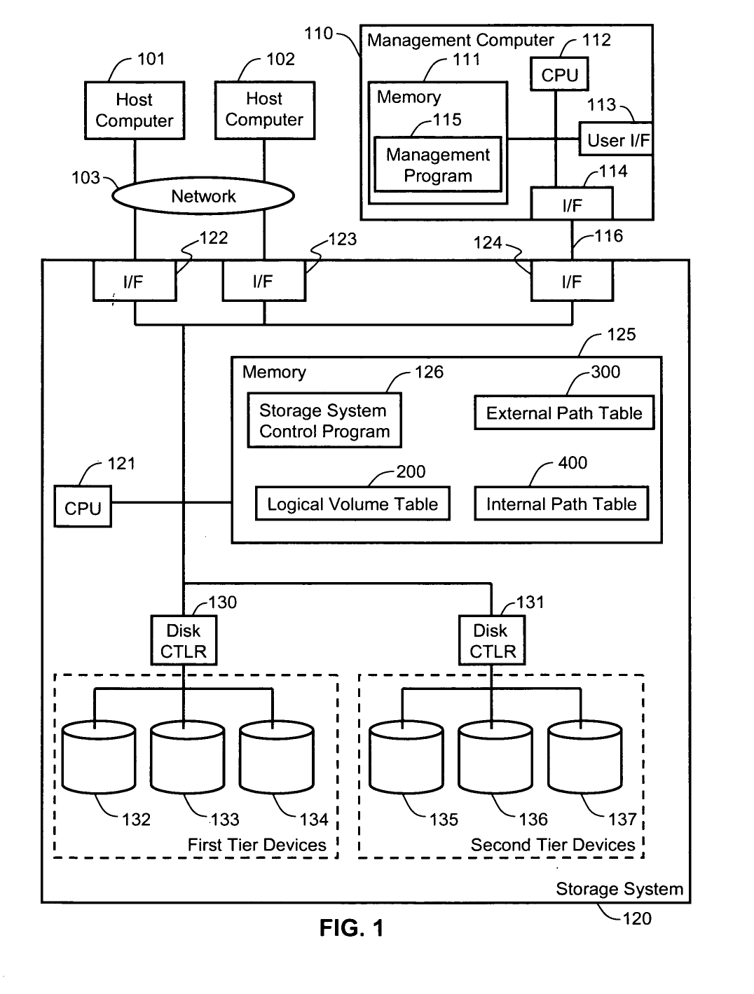

In the following embodiments, a single instance function is applied to files in the same tier. However, even if there are two identical files, the single instance function is not applied if these files are stored in different tiers of storage. FIG. 1 illustrates an overview of a computer storage system in which the method and apparatus of this invention may be applied, with it being understood that the invention is not limited to any specific hardware structure.

Host computers 101 and 102 are connected to a storage system 120 via a network 103. Network 103 is preferably a local area network (LAN), but may be another type of network, such as a wide area network (WAN), storage area network (SAN), WiFi, or the like, and is not limited to a particular network protocol. Host computers 101, 102 are able to access data stored in storage system 120, and store new data to files contained therein via network interfaces (I/Fs) 122,123, which may be network interface cards, ports, or the like, depending on the network protocol being used. Alternatively, of course, host computers 101, 102 may be directly connected to storage system 120 via cable link. Further, while only two host computers 101, 102 are shown, it should be understood that more than two hosts may be able to be connected for communication with storage system 120.

Storage system 120 may be controlled by an administrator through a user interface (User I/F) 113 of a management computer 110. Management computer 110 includes a CPU 112 that executes a management program 115 in a memory 111 of management computer 110 for communicating with and configuring storage system 120. Management computer 110 is connected for communication with storage system 120 through a communication interface 114 at management computer 110 and a communication interface 124 on storage system 120. Interfaces 114, 124 may be connected to enable communication via network 103, or may be enabled to communicate via a separate network or direct cable connection 116, such as a LAN cable (e.g, RJ45 networking cable, etc.).

Storage system 120 includes a CPU 121 that executes a storage system control program 126 able to be stored in memory 125 or other computer readable medium. Storage system control program 126 processes input/output (I/O) requests sent from host computers 101, 102 and enables communication of storage system 120 with management computer 110.

Storage system 120 includes a plurality of first tier storage devices 132-134 that are able to provide high performance and high reliability, and that are accessed through a first disk controller 130. Storage system 120 also includes a plurality of second tier storage devices 135-137 that provide inexpensive large storage capacity and that are accessed through a second disk controller 131. In the preferred embodiment, first tier devices 132-134 are FC HDDs while second tier devices 135-137 are SATA HDDs, but it should be understood that other types of nonvolatile storage devices and media may also serve as one or the other tier of storage devices, such as PSATA HDDs or SCSI HDDs. In addition, while the present embodiment illustrates two tiers, the invention may also be applied to more than two tiers. Further, while three devices are shown in each tier for convenience of illustration, it is well understood in the art that many more than three disk drives may be present in each tier at the storage system 120.

A plurality of logical volumes may be allocated storage space on storage devices 132-137 by storage system control program 126, with each volume typically being allocated on only a single tier of storage. Further, the logical volumes may be allocated across multiple storage devices of a tier in a RAID configuration to provide for parity protection, or in other known arrangements.

The invention also provides for a logical volume table 200 that stores information about logical volumes, an external path table 300 that stores information about external paths of each file, and an internal path table 400 that stores information about internal paths of each file. Each of these tables 200, 300, 400 may be stored in memory 125, and is discussed in greater detail below.

As illustrated in FIG. 2, for each logical volume allocated storage space on the storage devices 132-137, logical volume table 200 contains an external path entry 201 by which host computers identify a logical volume, a volume ID entry 202 by which storage system control program 126 identifies a logical volume internally, and a tier entry 203 that indicates in which tier of storage a logical volume is allocated. For example, if the tier of a logical volume is “1”, the logical volume is allocated space in the first tier disk drives 132-134, while if the tier is “2”, the volume is allocated space in the second tier disk drives 135-137.

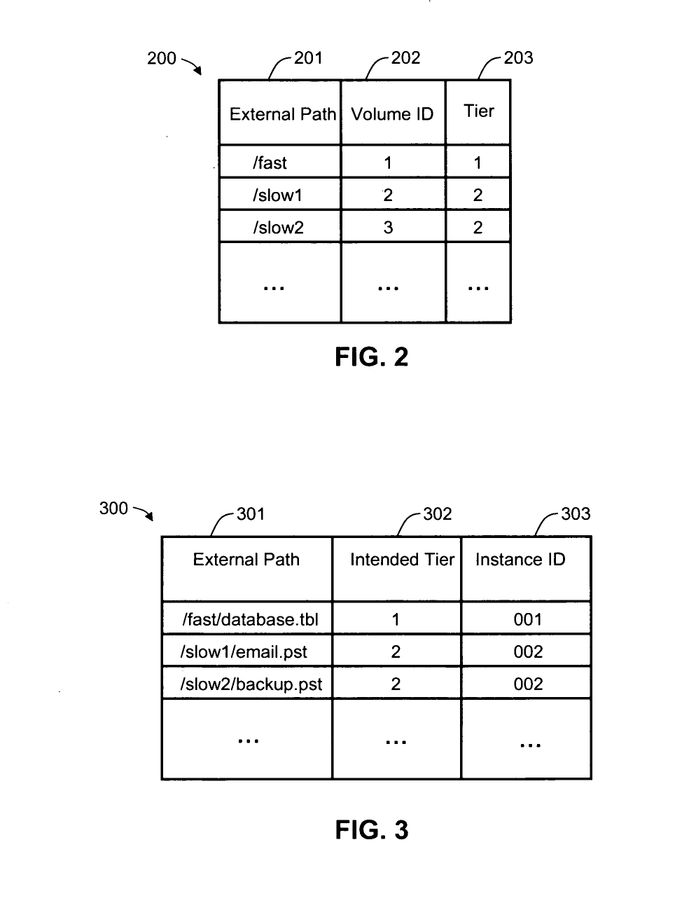

As illustrated in FIG. 3, for each file stored in storage system 120, external path table 300 contains an external path entry 301 by which host computers 101, 102 are able to identify the file. Also in external path table 300 is an intended tier entry 302 that indicates in which tier the file is originally stored, and an instance ID entry 303 that is a unique identifier of an instance of the file used by the storage system for identifying the instance. The intended tier is able to be determined from volume table 200 if the entry in the external file table is a new entry. Further, the intended tier for an instance and the actual tier that contains the instance may be different, as discussed below in the embodiments relating to volume groups. Thus, the external path table enables the storage system to receive the external path used by the host computers to identify and access a file, and use this external path to determine whether there is an existing entry having the same external path, and what the instance ID is for that entry.

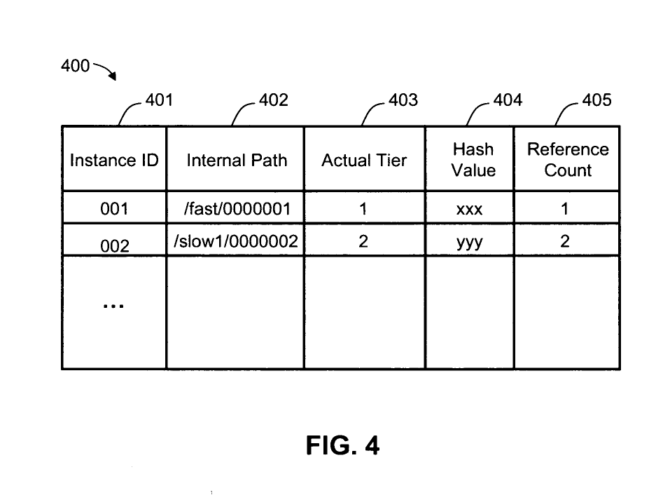

FIG. 4 illustrates an exemplary internal path table 400. For each instance of the files, internal path table 400 contains an instance ID 401, an internal path 402, which is an internal path to the instance file, an actual tier 403 that the instance is stored in, a hash value 404 used to detect identical instances, and a reference count 405 that indicates how many files refer to the instance. Thus, the internal path table identifies the internal path that the storage system uses for specifying the location of the actual data of each instance.

For example, in FIG. 3, a file that has an external path “/slow1/email.pst” is intended to be stored in the second tier because the external path “/slow1” is contained in a logical volume in the second tier, as is indicated by the logical volume having a volume ID of “2” in the logical volume table 200 of FIG. 2. The instance ID of the file is “002”, as is determined from entry 303 of external path table 300. Referring to the internal path table of FIG. 4, the instance is stored as a file /slow1/0000002 in the second tier storage and has a reference count of “2”, that is, there are two files which have identical content, i.e., same instance.

Accessing Files

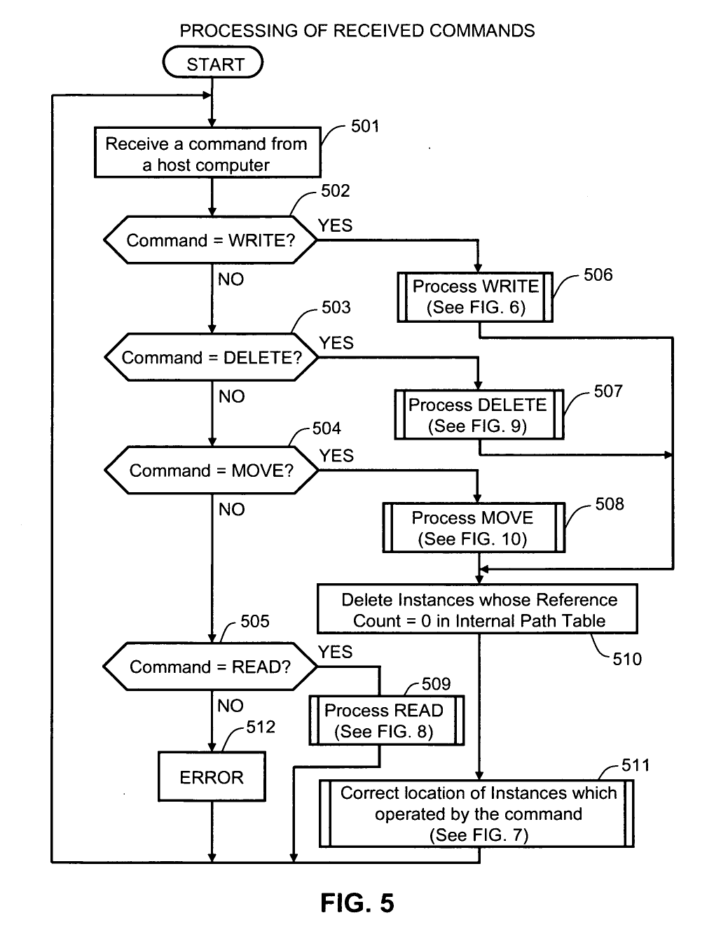

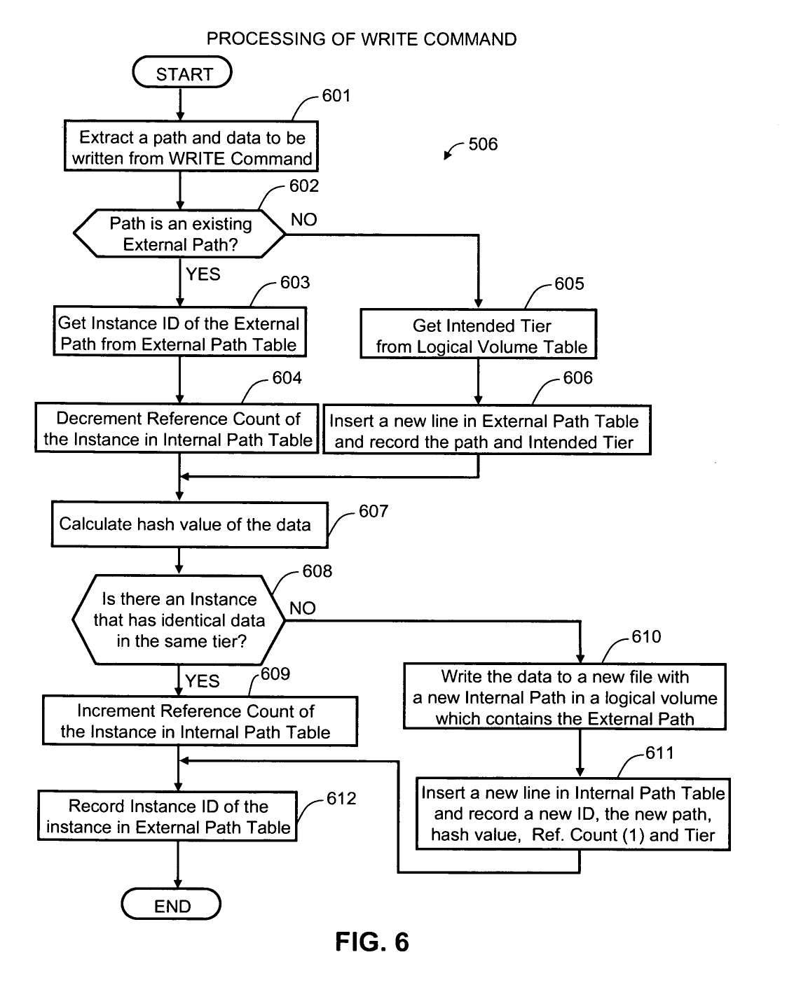

FIG. 5 illustrates an exemplary process flow of storage system control program 126 to process received commands from host computers to access files. The commands illustrated are WRITE, READ, DELETE, and MOVE commands. The Write command contains a path of a file to be accessed, and the contents (data) to be written. Read and Delete commands contain a path of a file to be accessed or deleted, respectively. The Move command contains an original (source) path of a file and a new (destination) path of the file. Note, however, that the Move command may be used to merely change the name of a file, rather than to actually move the data to a different volume, if for example, only the file name at the end of the path is changed. The detailed processes carried out for each of these commands, steps 506-509, are described later in FIGS. 6 and 8-10.

At Step 501, a command from a host is received by the storage system 120.

At Step 502, the storage system control program 126 checks whether the command is a Write command. If so, the command is processed at Step 506 as described with reference to FIG. 6, if not, the process proceeds to Step 503.

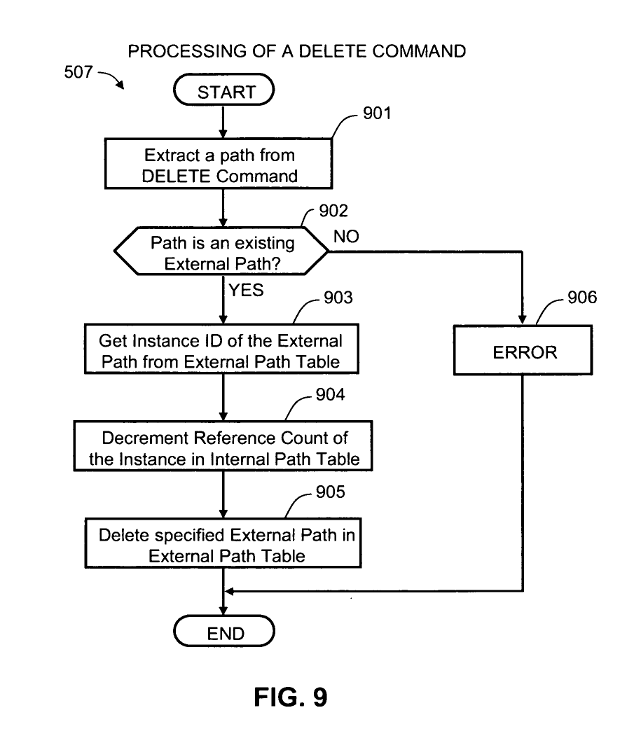

At Step 503, the storage system control program 126 checks whether the command is a Delete command. If so, the command is processed at Step 507 as described with reference to FIG. 9, if not, the process proceeds to Step 504.

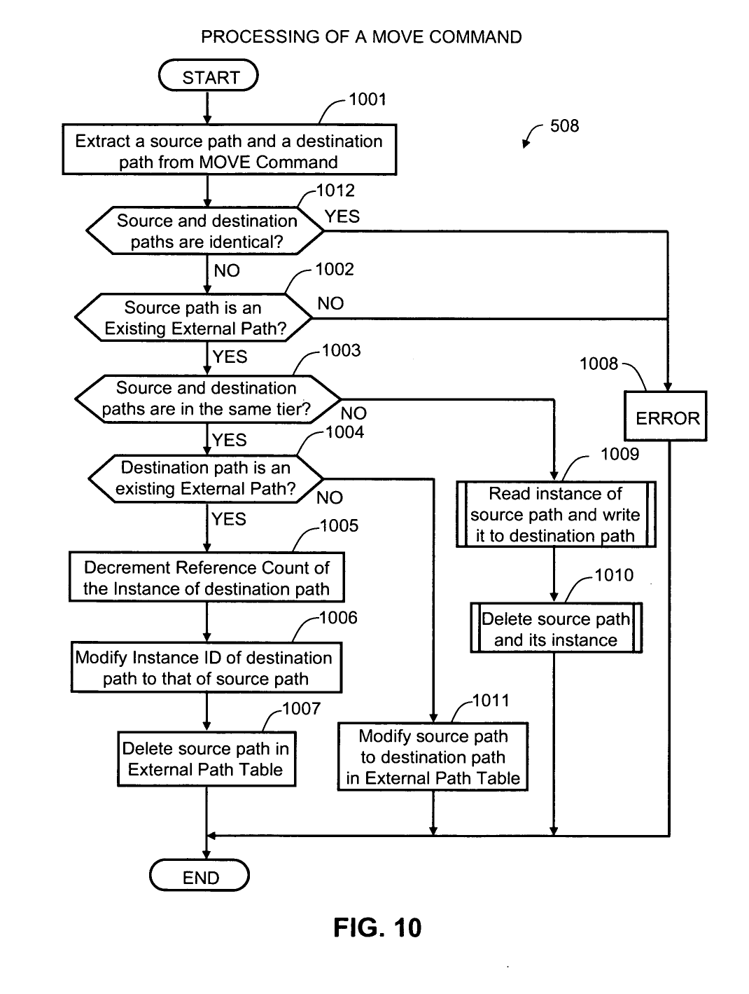

At Step 504, the storage system control program 126 checks whether the command is a Move command. If so, the command is processed at Step 508 as described with reference to FIG. 10, if not, the process proceeds to Step 505.

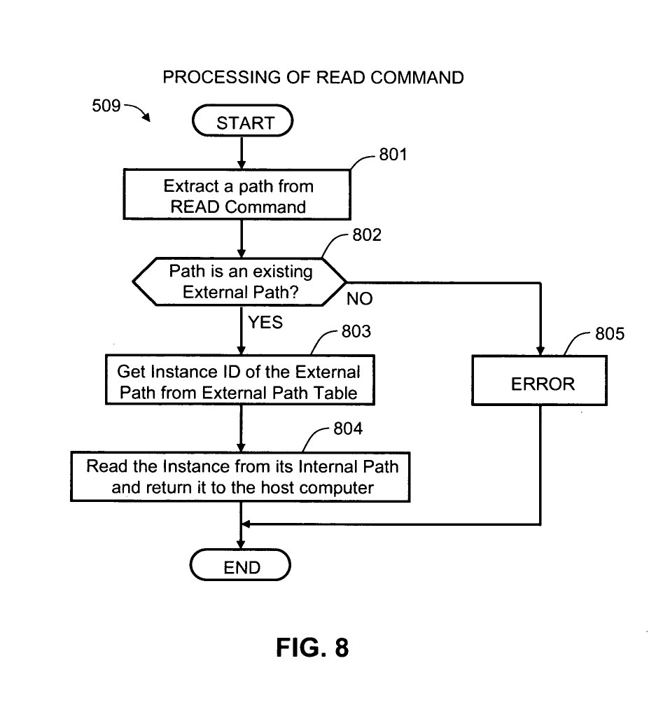

At Step 505, the storage system control program 126 checks whether the command is a Read command. If so, the command is processed at Step 509 as described with reference to FIG. 8, if not, the process proceeds to Step 512 and returns an error since the storage system control program 126 does not recognize the command.

After a Write, Delete, or Move command is processed, then at Step 510, storage system control program 126 deletes any instances whose reference count=0 in internal path table 400 because this means that there are no files that refer to those instances anymore. A file which stores the instance is identified by its internal path and is deleted, and the entry for the instance in the internal path table 400 is also deleted.

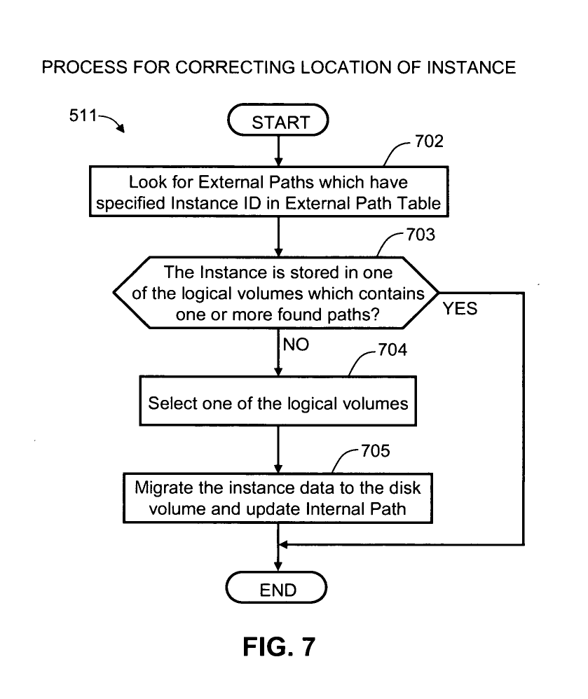

In Step 511, locations of instances operated on by the Write, Delete or Move commands are corrected. For example, if an instance is stored in a logical volume identified by external path “/slow1” and this instance is referred by two files “/slow1/file1” and “/slow2/file2”, then when “/slow1/file1” is deleted or changed by writing of new data, only “/slow2/file2” refers to the instance. However, the actual instance is still stored in the logical volume having the external path “/slow1”, even though the external path to the file “/slow2/file2” indicates that the file is stored in a different logical volume having an external path “/slow2”. That means a file to be only stored in logical volume “/slow2” consumes capacity of logical volume “/slow1”, which is undesirable from a capacity management standpoint. Accordingly, to correct this, in Step 511, the location of the data for the instance is modified to the logical volume “/slow2” in this case by migrating the data from volume “/slow1” to volume “/slow2”. The details of step 511 are described later with reference to FIG. 7.

Details of step 506 of FIG. 5 (processing of a WRITE command) are illustrated in FIG. 6.

At Step 601, the storage system control program 126 extracts a path and data to be written from the Write command received from the host.

At Step 602, the storage system control program 126 determines whether the extracted path is an existing external path by referring to the external path table 300.

At Step 603, if the specified path is an existing path, the instance ID of the external path is obtained from the external path table 300. Since the specified external path is an existing external path, the intended tier will not change.

At Step 604, the storage system control program 126 decrements the reference count of the instance in the internal path table 400 because the content of the file will be modified and therefore will no longer be the same as the instance referred to by the instance ID.

At Step 605, if the path contained in the Write command does not already exist in external path table 300, then the Write command is for a new external path. Accordingly, the storage system control program 126 obtains the intended tier from the logical volume table 200, by referring to the external path to see which logical volume is identified and then obtaining the tier for this volume from the logical volume table 200.

At Step 606, the storage system control program 126 creates a new entry in the external path table 300 by recording the path and intended tier.

At Step 607, storage system control program 126 calculates a hash value for the data received with the Write command.

At Step 608, the program searches for an existing instance that has an identical hash value, and that also has a value of actual tier that is equal to the intended tier of the file. If an instance is found that matches the hash value and is in the same tier, then its content is compared to the received data on a bit-by-bit basis, since it is possible that hash values can be the same but there might still be some differences in the actual content of the data.

At Step 609, if the storage system control program 126 determines that the received write data is identical to an existing instance that exists in the same tier, then instead of storing the received write data to the intended volume, the internal path table 400 is modified by incrementing the reference count 405 by one for the located instance that matches the received write data in content.

At Step 610, on the other hand, if the storage system control program 126 determines that an identical instance does not already exist, the received Write data is written with a new internal path to a new location in the logical volume identified by the specified external path received in the Write command.

At Step 611, the storage system control program 126 inserts a new line in the internal path table 400 and records a new instance ID 401, the new internal path 402, a new actual tier 403, the hash value 404 calculated at Step 607, and a reference count 405 of “1”, since this is the only instance so far of the data.

At Step 612, the storage system control program 126 records the instance ID 303 for the external path entry in the external path table 300.

As discussed above, following any Write, Delete or Move command, an instances whose reference counts=0 are deleted from the internal path table (Step 510 of FIG. 5), and the process for correcting location of an instance (Step 511 of FIG. 5) is carried out. For example, following the write command, since new data might be written to an existing external path, then if the old instance still exists in that volume, but is referenced by files in other volumes, the instance should be migrated to one of the other volumes still having files whose external paths refer to it. Details of step 511 of FIG. 5 are discussed with reference to FIG. 7.

At Step 702, the storage system control program 126 examines the external path table 300 to determine whether any external paths in the external path table have the specified instance ID in column 303.

At Step 703, the storage system control program 126 determines whether or not the instance is stored in one of the logical volumes that contain one or more of the found external paths. If the instance is not stored in one of the logical volumes that contain the found paths, then the process proceeds to step 704. However, if the instance is already stored in one of the logical volumes that contain the found paths, then the process can end since the instance is not stored in a volume that no longer is supposed to contain the data.

At Step 704, the storage system control program 126 chooses one of the volumes identified as containing the file that refers to the instance.

At Step 705, the storage system control program 126 migrates the data to the chosen logical volume that contains one or more external paths found in step 702 so that the instance does not consume the capacity of a logical volume that contains no file that refers to the instance. The internal path of the instance is updated in the internal path table 400 to accurately reflect the destination of the migration as the new internal path for that instance.

FIG. 8 illustrates the steps carried out when a Read command is processed by the storage system 120 (step 509 of FIG. 5).

At Step 801, the storage system control program 126 extracts a specified path from the received Read command.

At Step 802, the storage system control program 126 determines whether the specified path is an existing path by examining external path table 300. If the path is not an existing path, then at Step 805 an error is returned.

At Step 803, when the storage system control program 126 has determined that the specified path exists in the external path table 300, the instance ID of the specified external path is retrieved from the external path table 300.

At Step 804, the storage system control program 126 refers to the internal path table 400 to determine the internal path corresponding to the instance ID. The instance read based upon the determined internal path, and the data contained in the instance is returned to the requesting host computer.

FIG. 9 illustrates the steps carried out when a Delete command is processed by the storage system 120 (step 507 of FIG. 5).

At Step 901, the storage system control program 126 extracts a specified path from the Delete command received from the host computer.

At Step 902, the storage system control program 126 determines whether the specified path is an existing path by examining external path table 300. If the path is not an existing path, then at Step 906 an error is returned.

At Step 903, when the storage system control program 126 has determined that the specified path exists in the external path table 300, the instance ID of the specified external path is identified from the external path table 300.

At Step 904, the storage system control program 126 decrements the reference count of the identified instance in the internal path table 400.

At Step 905, the storage system control program 126 deletes the specified external path for the file in the external path table 300. Subsequently, Steps 510 and 511 of FIG. 5 are also carried out, as described above to complete deletion of the file.

FIG. 10 illustrates the steps carried out when a Move command is processed by the storage system 120 (step 508 of FIG. 5). Note that the Move command is used for changing the path of the file. Thus, this command may be used for merely renaming a file, while the file is not actually “moved”, or it may be used to specify a new directory or volume for a file. When a new volume is specified by the Move command, step 511 of FIG. 5 ensures that the specified data is actually migrated, if necessary.

At Step 1001, the storage system control program 126 extracts a specified source path and destination path from the Move command received from the host computer.

At Step 1012, the storage system control program 126 determines whether the specified source and destination paths are identical. If they are identical, then at Step 1008 an error is returned.

At Step 1002, the storage system control program 126 determines whether the specified source path is an existing path by examining external path table 300. If the specified source path is not an existing path, then at Step 1008 an error is returned.

At Step 1003, the storage system control program 126 determines whether the source path and the destination path are in the same tier by referring to the logical volume table 200 to determine that the logical volumes specified by each external path are in the same tier. If they are in the same tier, the process proceeds to step 1004, and if not, the process goes to step 1009.

At Step 1004, if both the source and destination paths are in the same tier, then the storage system control program 126 determines whether the destination path is an existing external path by referring to the external path table 300. If the destination path is an existing path, the process goes to step 1005. If the destination path is not an existing path, then at step 1011, the source path in the external path table 300 is modified to the destination path, and the process ends.

At Step 1005, if the destination path is an existing path, the storage system control program 126 decrements the reference count 405 of the instance of the destination path in the internal path table 400. This decrementing occurs because the source path is being changed to an existing destination path, so there will now be one less file referring to that instance.

At Step 1006, the storage system control program 126 modifies the instance ID of the destination path to the instance ID of the source path in the external path table 300.

At Step 1007, the storage system control program 126 deletes the source path from the external path table and this portion of the process ends.

At Step 1009, if the destination path is in a different tier than the source path, the storage system control program 126 must migrate the file to the other tier unless the instance of the file already exists in the other tier. This involves a process that is a combination of the Read command of FIG. 8 in which the data is read from the source path, and the Write command of FIG. 6 in which the data is written to the destination path in the specified tier unless an instance of the data already exists.

At Step 1010, the storage system control program 126 uses the same steps as the Delete command of FIG. 9 to deletes the source path from the original tier.

By the process described above, single instance function is applied to only files in the same tier to make instances stored in appropriate tiers and provide expected performance and reliability for each file according to its specified tier. Further, in the embodiments described above, the usual difference of the tiers is performance and reliability. However, there can be other characteristics that distinguish tiers. For example, if a first tier encrypts stored data and a second tier does not encrypt data, then this invention can be used to provide designated security for each file as either encrypted or non-encrypted.

In the embodiments described above, the single instance function is applied to files in the same tier, but not across tiers. However, other embodiments described below, the single instance is applied according to specified groups of logical volumes, and the single instance function is thus applied to files in the same group even if the group encompasses multiple tiers. For example, different users (or applications) might want to have different groups of volumes to avoid sharing instances of files. If two users share an instance, a READ operation by one user can be delayed or disrupted by a READ operation by another user. Thus, to eliminate performance interference among users, each user may have his or her own volume group. According this embodiment, the single instance function is applied to files in defined groups of logical volumes. In each group, if two files in different tiers are identical, the instance of these files is stored in the higher tier because the file in higher tier is expected to provide better performance and reliability which is expected at a minimum for at least one of the instances.

For the embodiments relating to volume groups, FIG. 5 illustrating the processing of received commands is equally applicable, and unchanged, as are FIGS. 1-4 and 8-9. Accordingly, these do not need to be discussed further for this embodiment. However, the processes for processing the Write and Move commands, and the process for correcting location of an instance are different, as described in detail below.

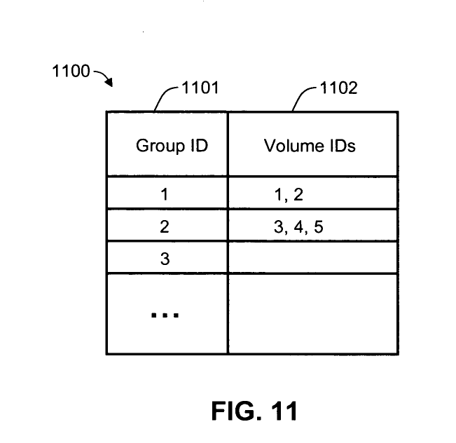

FIG. 11 illustrates a grouping table 1100 that defines the groups of logical volumes according to group. In grouping table 1100, a group ID 1101 is provided for each group of logical volumes 1102. For example, Group 1 contains logical volumes 1 and 2, and logical volume 1 might be in a first tier, while logical volume 2 might be in a second tier, as may be determined from logical volume table 200.

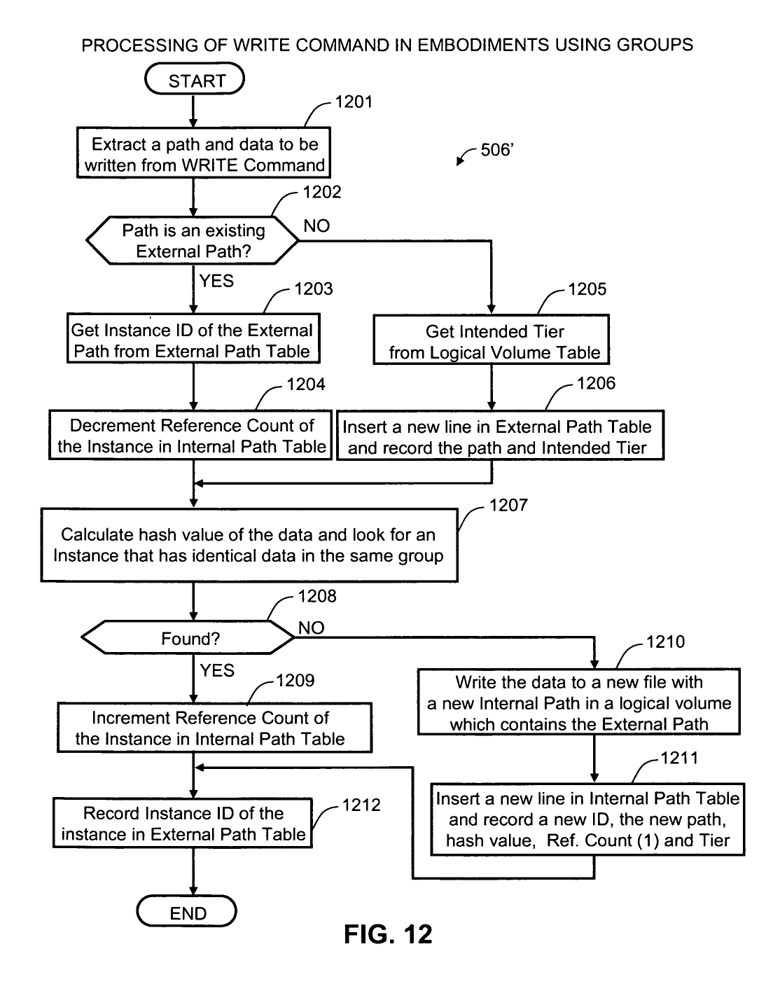

FIG. 12 illustrates a modified process for a write command 506′ received by the storage system when volume groups must be taken into account. In FIG. 12, steps 1201-1206 are identical to steps 601-606, respectively, of FIG. 6 described above, and accordingly do not need to be described again here.

At Step 1207, storage system control program 126 calculates a hash value for the data received with the Write command.

At Step 1208, the program searches for an existing instance that has an identical hash value within the same group, rather than the same tier, as in step 607. If an instance is found that matches the hash value, then the content of the found instance is compared to the received data on a bit-by-bit basis since it is possible that hash values might be the same, but there are still some differences in the actual content.

At Step 1209, if the storage system control program 126 determines that the received write data is identical to an existing instance that exists in the same group, then instead of storing the received write data to the intended volume, the internal path table 400 is modified by incrementing the reference count 405 by one.

At Step 1210, on the other hand, if the storage system control program 126 determines that an identical instance does not already exist in the same group, the received write data is written to a new file with a new internal path in the logical volume identified by the specified external path specified by the Write command.

At Step 1211, the storage system control program 126 inserts a new line in the internal path table 400 and records a new instance ID 401, a new internal path 402, a new actual tier 403, a new hash value 404, and a reference count 405 of “1”, since this is the only instance so far of the data.

At Step 1212, the storage system control program 126 records a new instance ID 303 for the instance in the external path table 300.

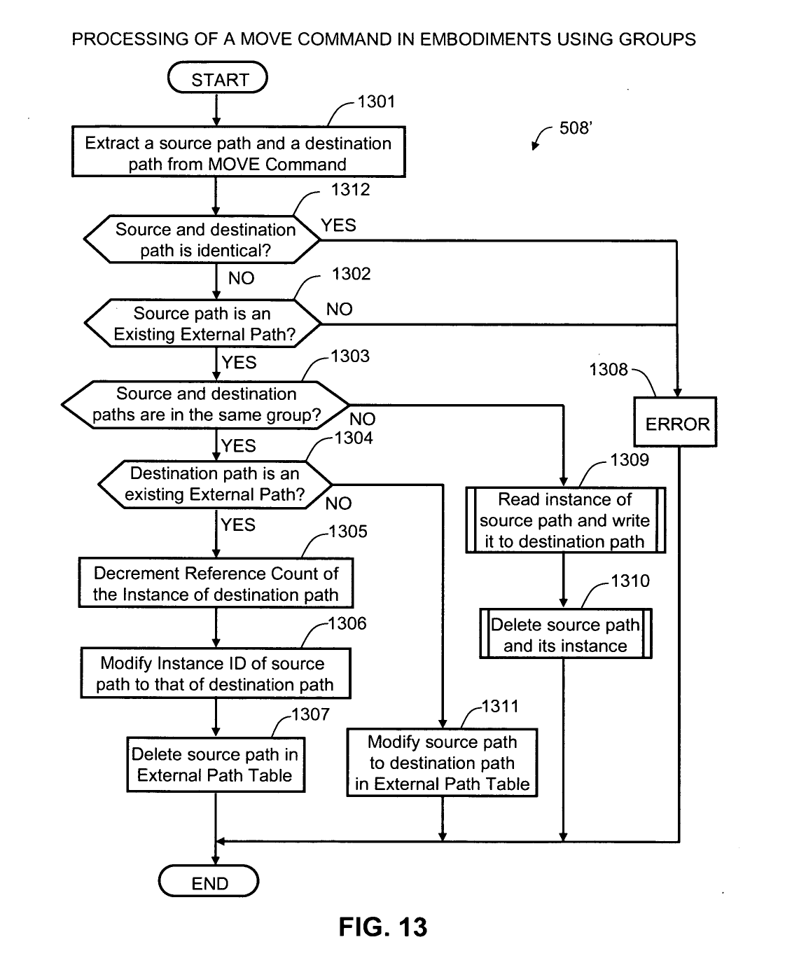

FIG. 13 illustrates a modified process for a Move command 508′ received by the storage system when volumes classified into groups must be taken into account. In FIG. 13, steps 1301, 1312, and 1302 are identical to steps 1001, 1012, and 1002, respectively, of FIG. 10 described above, and accordingly do not need to be described again here.

At Step 1303, the storage system control program 126 determines whether the source path and the destination path are in the same group by referring to the logical volume table 200 to determine the logical volumes specified by each path and by referring to the grouping table 1100 to determine if the specified logical volumes are in the same group. If they are in the same group, the process proceeds to step 1304, and if not, the process goes to step 1309. Steps 1304-1311 are identical to steps 1004-1011, respectively, of FIG. 10 described above, and accordingly do not need to be described again here.

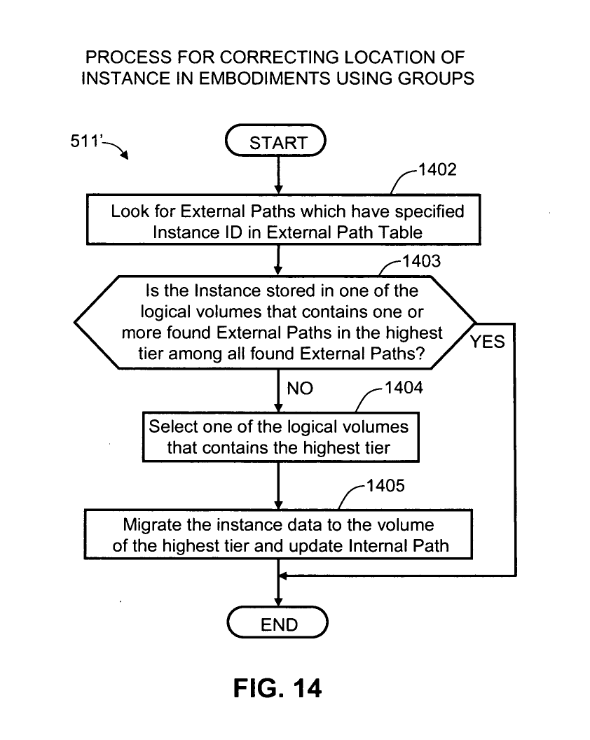

As discussed above, following any Write, Delete or Move command, the process for correcting a location of an instance is carried out. For the embodiments where the volumes are classified into volume groups, the process of correcting the location of an instance 511 illustrated in FIG. 7 is also modified. The modified process for correcting the location of an instance 511′ is illustrated in FIG. 14.

At Step 1402, the storage system control program 126 examines the external path table 300 to determine whether any external paths in the external path table have the specified instance ID in column 303, which is the same as Step 702 of FIG. 7.

At Step 1403, the storage system control program 126 determines whether the instance is stored in one of the logical volumes in the group that contains one or more external paths of the file, and determines that instance is stored in the highest tier if it is referred to by files in more than one tier. If the instance is not stored in one of the logical volumes that contain the found paths in the highest tier, then the process proceeds to step 1404. However, if the instance is stored in one of the logical volumes that contains the found paths in the highest tier, the process can end since the instance is not stored in a volume that is no longer supposed to contain the data, and the volume which contains the instance can provide intended quality of service at least.

At Step 1404, the storage system control program 126 chooses one of the volumes in the group for the identified instance that is identified as containing the file that refers to the instance that is in the intended highest tier specified for any of the files that refer to the instance.

At Step 1405, the storage system control program 126 migrates the data of the instance that contains one or more external paths found in step 1402 so that the instance is located in a the selected disk volume that is in the higher tier and does not consume the capacity of a logical volume that contains no file that refers to the instance. The internal path of the instance is updated in the internal path table 400 to accurately reflect the destination of the migration as the new internal path for that instance.

Tiered storage systems are effective for reducing the average bit cost of overall storage capacity and are becoming more common in IT systems. Under the invention, the single instance function is able to be integrated with the management of the tiers and applied depending on the characteristics of each tier. Thus, it may be seen that the invention provides a means for effectively reducing the consumption of storage capacity while not affecting expected characteristics of the stored data, such as performance. Further, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the above description has been made in an illustrative fashion, and not a restrictive one. Accordingly, the scope of the invention should properly be determined with reference to the appended claims, along with the full range of equivalents to which such claims are entitled.

What is claimed is:

1. A method of storing data, comprising:
providing a storage system having a first tier of storage and a second tier of storage;
receiving a first data for storage to the storage system said first data including an indication of an intended tier of storage of either said first tier or said second tier;
determining whether an identical instance of said first data is already stored in said intended tier;
storing said first data to said intended tier of storage when no identical instance of the first data is already stored in said intended tier; and
storing a first path to said identical instance instead of storing said first data when said identical instance is already stored in said intended tier.

2. A method according to claim 1, further including steps of
calculating hash values for files stored in said storage system; and
determining whether an identical instance of said first data exists by calculating a first hash value for said first data and comparing said first hash value with the hash values calculated for the files stored in the intended tier of storage.

3. A method according to claim 1, further including a step of
providing instance IDs for separate instances of files stored in each tier in said storage system, said instance IDs correlating external paths for the files stored in said storage system with internal paths, said external paths being used by a computer to identify storage paths of the files, said internal paths being used by the storage system to identify locations where data of said instances of said files are stored.

4. A method according to claim 3, further including a step of
managing a reference count for each instance ID, each said reference count indicating a number of external paths that refer to the instance of the file identified by that instance ID.

5. A method according to claim 4, further including steps of
extracting a first external path from a first write command included with said first data received by said storage system;
determining whether said first external path matches an existing external path;
getting a first instance ID for said first external path if said first external path matches an existing external path; and
decrementing the reference count for said first instance ID.

6. A method according to claim 3, further including steps of
responding to a first read request by extracting a first external path from the read request;
getting a first instance ID corresponding to the first external path extracted from the first read request; and
reading stored data according to a first internal path corresponding to said first instance ID and returning the stored data in response to the read request.

7. A method according to claim 1, further including a step of
providing a plurality of a first type of hard disk drives as storage devices for said first tier of storage and a plurality of second type of hard disk drives as storage devices for said second tier of storage, said first type of hard disk drives having higher performance and reliability than said second type of hard disk drives.

8. A method according to claim 1, further including a step of
encrypting data stored in said first tier of storage and not encrypting data stored in said second tier of storage.

9. A method of storing data, comprising:
providing a plurality of volumes having allocated storage space in a storage system, said storage system being in communication with a computer able to access said volumes and store data thereto, said storage system including a first tier of storage and a second tier of storage, said first tier being a higher tier than said second tier in a hierarchy of tiers;
grouping said volumes into a plurality of groups;
receiving a first data, said first data including an indication of a first volume in which the first data is intended to be stored, said first volume being a member of a first group of said plurality of groups;
determining an intended tier of storage for said first data from among said first and second tiers of storage;
determining whether an identical instance of said first data is already stored in said first group;
storing said first data to said first group in the intended tier when no identical instance of the first data is already stored in said first tier of storage in said first group, unless said intended tier is said second tire of storage and an identical instance of said first write data is already stored in said second tier of storage in said first group; and
storing a path to the identical instance instead of storing said first data when the identical instance is stored in said first group and is stored in the intended tier or a tier higher than the intended tier.

10. A method according to claim 9, further including steps of
calculating hash values for files stored in said storage system;
determining whether an identical instance of said first data exists by calculating a first hash value for said first data and comparing said first hash value with the hash values calculated for the files stored in the first group.

11. A method according to claim 9, further including steps of
providing instance IDs for separate instances of files stored in said storage system, said instance IDs correlating external paths for the files stored in said storage system with internal paths, said external paths being used by a computer to identify storage paths of the files, said internal paths being used by the storage system to identify locations where data of said instances of said files are stored.

12. A method according to claim 11, further including steps of
managing a reference count for each instance ID, each said reference count indicating a number of external paths that refer to the instance of the file identified by that instance ID.

13. A method according to claim 12, further including steps of
extracting a first external path from a first write command included with said first data received by said storage system;
determining whether said first external path matches an existing external path;
getting a first instance ID for said first external path if said first external path matches an existing external path; and
decrementing the reference count for said first instance ID.

14. A method according to claim 12, further including steps of
responding to a first read request by extracting a first external path from the read request;
getting a first instance ID corresponding to the first external path extracted from the first read request;
reading stored data according to a first internal path corresponding to said first instance ID and returning the stored data in response to the read request.

15. A method according to claim 9, further including steps of
providing a plurality of a first type of hard disk drives as storage devices for said first tier of storage and a plurality of second type of hard disk drives as storage devices for said second tier of storage, said first type of hard disk drives having higher performance and reliability than said second type of hard disk drives.

16. A method according to claim 9, further including steps of
encrypting data stored in said first tier of storage and not encrypting data stored in said second tier of storage, wherein said encryption provides the higher tier of storage.

17. A method according to claim 9, further including a step of
providing a plurality of Fibre Channel hard disk drives as storage devices for said first tier of storage and a plurality of serial ATA hard disk drives as storage devices for said second tier of storage.

18. A method for storing data, comprising:
providing a storage system including a CPU, a memory and one or more interfaces for communicating with one or more computers, said one or more computers storing data to and reading data from disk drives at said storage system;
providing multiple said disk drives with some of said disk drives being first tier disk drives and some of said disk drives being second tier disk drives, wherein said first tier disk drives provide a higher level of performance than said second tier disk drives, such that said first tier disk drives provide a first tier of storage and said second tier disk drives provide a second tier of storage;
providing a storage system control program able to be stored in said memory, and executable by said CPU;
providing a plurality of logical volumes allocated storage space on said disk drives, wherein each of said logical volumes is allocated storage space on either the first tier disk drives or the second tier disk drives;
providing an external path table stored in said memory for correlating an external path for a file used by said computer with an instance ID assigned to the file;
providing an internal path table stored in said memory for correlating the instance ID assigned to the file with an internal path to the file location;
receiving, by the storage system, a first file identified for storage in said disk drives by a first external path including a first volume into which the first file is intended to be stored;
recording the first external path in the external path table if the first external path does not already exist in the external path table;
determining from said internal path table whether an instance of said first file already exists in an intended tier of storage in which said first volume exists;
storing said first file to said intended tier of storage when no identical instance of the first data is already stored in said intended tier and recording a new internal path and a new instance ID in said internal path table;
incrementing a reference count for the identical instance in the internal path table if the identical instance is already stored in the intended tier;
storing a first instance ID for said identical instance in said external path table when said identical instance is already stored in said intended tier; and
storing the new instance ID in said external path table when no identical instance of the first data is already stored in said intended tier.

19. A method according to claim 18, further including steps of
calculating hash values for files stored in said storage system and storing said hash values in said internal path table;
determining whether an identical instance of said first file exists by calculating a first hash value for said first file and comparing said first hash value with the hash values stored in the internal path table.

20. A method according to claim 18, further including a step of
providing a plurality of Fibre Channel hard disk drives as said first tier disk drives and a plurality of serial ATA hard disk drives as said second tier disk drives.
